(19) United States
(12) Patent Application Publication
(10) Pub. No.: US 2025/0154415 A1
(43) Pub. Date: May 15, 2025

(54) SYSTEMS AND METHODS FOR PRODUCING AVIATION FUEL

(71) Applicant: MARATHON PETROLEUM COMPANY LP, Findlay, OH (US)

(72) Inventor: William Jennings Bandy, III, Findlay, OH (US)

(21) Appl. No.: 18/919,759

(22) Filed: Oct. 18, 2024

Related U.S. Application Data
(60) Provisional application No. 63/548,081, filed on Nov. 10, 2023.

(51) Int. Cl. C10G 69/02

(52) U.S. Cl. CPC C10G 69/02; C10G 2300/1055; C10G 2400/08

(57) ABSTRACT

Embodiments of systems and methods to produce aviation fuel are disclosed. An example of a method to produce aviation fuel includes fractionating a renewable diesel feedstock in a fractionator to produce a C₈₋ fraction, a C₈₋₁₈ fraction, and a C₁₈₊ fraction. Additionally, the method includes providing the C₈₋₁₈ fraction to an isomerization reactor to produce an aviation fuel product. The method includes supplying at least a portion of the C₁₈₊ fraction to a hydrocracking reactor to produce a hydrocracked product. The method further includes recycling at least a portion of the hydrocracked product to the fractionator for fractionating along with the renewable diesel feedstock.

### CROSS REFERENCE TO RELATED APPLICATIONS

This application claims priority to, and the benefit of U.S. Provisional Application No. 63/548,081, filed Nov. 10, 2023, titled “SYSTEMS AND METHODS FOR PRODUCING AVIATION FUEL,” the disclosure of which is incorporated herein by reference in its entirety.

### TECHNICAL FIELD

The disclosure is generally related to aviation fuel. More specifically, the disclosure relates to systems and methods for producing aviation fuels, such as synthetic paraffinic kerosene (SPK) or sustainable aviation fuel (SAF).

### BACKGROUND

An increasing number of facilities are implementing renewable feedstock or materials to provide sustainable transportation fuels, which may include a reduced environmental impact compared to fossil-based fuels. Certain aviation fuels may be developed from renewable feedstocks to include chemical properties suitable for powering aircrafts. In some cases, these fuels are referred to as synthetic paraffinic kerosene (SPK), which can be used directly as a sustainable aviation fuel (SAF) or blended with any other fuel or product to produce SAF having desired properties. Traditional process flow schemes for creating aviation fuel include directing a feedstock into an isomerization unit, then a fractionation unit, and then a hydrocracking unit. This process flow therefore directs all compounds of the feedstock directly into the isomerization unit, including large-size compounds that are subsequently cracked in the hydrocracking unit for size reduction. Isomerization of these compounds negatively contribute to the operating conditions and design considerations of various components, such as the hydrocracking unit. For example, certain situations necessitate management of molecular sizes and freeze points of the various compounds for both the isomerization unit and the hydrocracking unit, which are overly complex and problematic. Moreover, single pass hydrocracking in the traditional process flow schemes require removal of a drag stream of unconverted compounds that are too large or otherwise unsuitable for jet fuel use. The drag stream, which may be supplied or retailed as renewable diesel, further reduces yield or efficiency of aviation fuel production.

### SUMMARY

Accordingly, Applicant has recognized a need for systems and methods to provide enhanced yield of aviation fuel from a renewable diesel feedstock. The present disclosure is directed to embodiments of systems and methods for producing aviation fuel.

Embodiments of refining systems disclosed herein include a configuration of process units for an enhanced yield of aviation fuel, such as synthetic paraffinic kerosene (SPK) or sustainable aviation fuel (SAF). In some examples, SPK is a blendstock that is blended with an aromatic-rich fuel according to one or more ASTM standards to produce SAF having specified properties. For example, the SPK may be blended with a sustainably sourced fuel and/or a petroleum-derived fuel to produce SAF that includes a threshold content of aromatic compounds therein. As used herein, the aviation fuel produced according to the present techniques refers to any suitable SPK, SAF, or renewable jet fuel that includes physical and chemical properties suitable for aviation use. The presently disclosed refining systems provide a disruption and reversal of the conventional order of dewaxing reactions (hydrocracking and isomerization) and the fractionator to provide a more efficient processing of the feedstock. The systems facilitate simpler and potentially lower severity in operation of the hydrocracking and isomerization units for increased yield. For example, compounds that are outside the boiling point ranges of aviation fuel are recycled to extinction, thereby providing aviation fuel as one of the main distillate products. In certain examples, the aviation fuel is the main distillate product. In an example, the system includes the fractionator and hydrocracking reactor being positioned upstream of the isomerization reactor to drive product separation; thereby providing only specific, targeted compounds to each reaction step. In certain examples, this configuration reduces over-cracking that produces undesired light ends, maximizing the aviation fuel yield. The configuration also enables each reaction step (hydrocracking and isomerization) to have a focused processing operation. The refining systems and methods disclosed herein separate normal alkanes into fractions that are supplied to their respective upgrading processes to modify molecular sizes and qualities for increased production of aviation fuel.

An embodiment of the disclosure is directed to a method to produce aviation fuel. The method may include fractionating a renewable diesel feedstock in a fractionator to produce a C₈₋ fraction, a C₈₋₁₈ fraction, and a C₁₈, fraction. The C₈₋ fraction is further processed to produce naphtha, LPG, or fuel gas (collectively referred to as light ends). Additionally, the method includes providing the C₈₋₁₈ fraction to an isomerization reactor to produce an aviation fuel product. The method also includes supplying at least a portion of the C₁₈₊ fraction to a hydrocracking reactor to produce a hydrocracked product and recycling at least a portion of the hydrocracked product to the fractionator for fractionating along with the renewable diesel feedstock.

In another example, the renewable diesel feedstock includes a hydrodeoxygenated renewable diesel. In another example, the renewable diesel feedstock contains normal alkanes produced by hydrodeoxygenation of glycerides. In another example, the method may further include hydrotreating a renewable feedstock containing triglycerides, triglyceride derivatives, or a combination thereof in a hydrogen-rich atmosphere to produce the renewable diesel feedstock.

In another example, the method may further include mixing the hydrocracked product with the renewable diesel feedstock directly upstream of the fractionator. In another example, the renewable diesel feedstock is supplied to a first inlet of the fractionator and the at least a portion of the hydrocracked product is supplied to a second inlet of the fractionator. In another example, the recycling at least a portion of the hydrocracked product to the fractionator further includes recycling an entirety of the hydrocracked product. In another example, the method may further include producing an additional C₈₋ fraction in the isomerization reactor, providing the aviation fuel product and the additional C₈₋ fraction to a separator to separate the aviation fuel product from the additional C₈₋ fraction. The method may include recycling the additional C₈₋ fraction to the fractionator. The method may include further processing of the C₈₋ fraction to produce a plurality of light ends. In another example, the method may further include selecting an operating temperature of the hydrocracking reactor. The operating temperature may be lower than an operating temperature of a hydrocracking reactor positioned downstream of a reference isomerization reactor.

Another embodiments of the disclosure is directed to a method to produce aviation fuel. The method may include supplying a hydrodeoxygenated renewable diesel feedstock to a fractionator. The method includes fractionating the hydrodeoxygenated renewable diesel feedstock into a C₈₋ fraction, a C₈₋₁₈ fraction, and a C₁₈₊ fraction. The method includes providing the C₈₋₁₈ fraction to an isomerization reactor to produce an aviation fuel product. The method includes supplying at least a portion of the C₁₈₊ fraction to a hydrocracking reactor to produce a hydrocracked product. The hydrocracking reactor is configured to crack one or more heavy compounds of the C₁₈₊ fraction into two or more lighter compounds. The method also includes recycling at least a portion of the hydrocracked product to the fractionator.

In another example, the method may further include hydrodeoxygenating a triglyceride feedstock to produce the hydrodeoxygenated renewable diesel feedstock. In another example, the method may further include producing an additional C₈₋ fraction in the isomerization reactor, providing the aviation fuel product and the additional C₈₋ fraction to a separator to separate the aviation fuel product from the additional C₈₋ fraction, and recycling the additional C₈₋ fraction to the fractionator.

Another embodiment of the disclosure is directed to a system to produce an aviation fuel. The system includes a fractionator having a first inlet to receive a renewable diesel feedstock, a first outlet, a second outlet, and a third outlet. The fractionator is configured to fractionate the renewable diesel feedstock into a C₈₋ fraction output that exits through the first outlet, a C₈₋₁₈ fraction output to the second outlet, and a C₁₈₊ fraction output to the third outlet. The system also includes a hydrocracking reactor having a second inlet and a fourth outlet. The second inlet is connected to and in fluid communication with the third outlet to receive the C₁₈₊ fraction. The hydrocracking reactor is configured to hydrocrack the C₁₈₊ fraction into a hydrocracked product. The fourth outlet is in fluid communication with the fractionator and facilitates recycling of the hydrocracked product to the fractionator. Additionally, the system may include an isomerization reactor having a third inlet and a fifth outlet. The third inlet may be connected to and in fluid communication with the second outlet to receive the C₈₋₁₈ fraction. The isomerization reactor may be operable to isomerize the C₈₋₁₈ fraction and supply an aviation fuel product as output through the fifth outlet.

In certain examples, the renewable diesel feedstock contains normal alkanes produced by hydrodeoxygenation of glycerides, free fatty acids, or combinations thereof. In some examples, a majority of the hydrodeoxygenated renewable diesel contains C₁₆ and C₁₈ normal alkanes. In some examples, the system may include a separator having a fifth inlet connected to and in fluid communication with the fifth outlet, a sixth outlet to supply an additional C₈₋ fraction to the fractionator, and a seventh outlet to output the aviation fuel product. In another example, the fourth outlet is connected to and in fluid communication with the first inlet or an additional inlet of the fractionator. In another example, the system may include a hydrogen source connected to and in fluid communication with the hydrocracking reactor, the isomerization reactor, or both.

In some examples, the system may include a controller in signal communication with the fractionator, the hydrocracking reactor, and the isomerization reactor. The controller may be configured to transmit signals to one or more of the fractionator, the hydrocracking reactor, and the isomerization reactor to adjust production of the aviation fuel product. In some examples, the controller is configured to adjust operation of the fractionator, the hydrocracking reactor, or both in response to detecting that the isomerization reactor is deviating from one or more preselected operating parameter ranges.

Another embodiment of the disclosure is directed to a controller to produce aviation fuel. The controller includes a memory storing processor-executable instructions. The controller also includes one or more processors communicatively coupled to the memory and configured to execute the processor-executable instructions from the memory. The one or more processors are configured, when executing the instructions, to transmit first signals to one or more first actuators associated with a fractionator to control operation thereof. The first signals cause the fractionator to fractionate a renewable diesel feedstock to produce a C₈₋ fraction, a C₈₋₁₈ fraction, and a C₁₈₊ fraction. The one or more processors are configured, when executing the instructions, to transmit second signals to one or more second actuators associated with an isomerization reactor to control operation thereof. The second signals cause the isomerization reactor to receive the C₈₋₁₈ fraction and produce an aviation fuel product. Additionally, the one or more processors are configured, when executing the instructions, to transmit third signals to one or more third actuators associated with a hydrocracking reactor to control operation thereof. The third signals cause the hydrocracking reactor to receive at least a portion of the C₁₈₊ fraction, produce a hydrocracked product, and direct at least a portion of the hydrocracked product in a recycle stream to the fractionator for fractionating along with the renewable diesel feedstock.

In certain examples, the one or more processors are configured, when executing the instructions, to control operation of the fractionator to within one or more first preselected operating parameter ranges, control operation of the isomerization reactor to within one or more second preselected operating parameter ranges, and control operation of the hydrocracking reactor to within one or more third preselected operating parameter ranges.

In some examples, the one or more processors are configured, when executing the instructions, to adjust operation of the hydrocracking reactor in response to detecting that the fractionator is deviating from the first preselected operating parameter ranges, and adjust operation of the fractionator in response to detecting that the hydrocracking reactor is deviating from the third preselected operating parameter ranges. In an example, the one or more processors are configured, when executing the instructions, to adjust operation of the fractionator, the hydrocracking reactor, or both in response to detecting that the isomerization reactor is deviating from the second preselected operating parameter ranges.

In certain examples, the one or more processors are configured, when executing the instructions, to update one or more of the first preselected operating parameter ranges, the second preselected operating parameter ranges, and the third preselected operating parameter ranges in response to receiving a respective, modified operating parameter range from an authorized computing device.

In another example, the controller is in signal communication with one or more sensors configured to provide sensor data associated with one or more operating parameters of the fractionator, the isomerization reactor, and the hydrocracking reactor. In some examples, one or more of the first actuators, the second actuators, and the third actuators include a control valve, a pump, a compressor, a heating element, or an electrical switch.

Still other aspects and advantages of these and other examples are discussed in detail herein. Moreover, it is to be understood that both the foregoing information and the following detailed description provide merely illustrative examples of various aspects and examples and are intended to provide an overview or framework for understanding the nature and character of the claimed aspects and examples. Accordingly, the advantages and features of the present disclosure will become more apparent through reference to the following description and the accompanying drawings. Furthermore, it is to be understood that the features of the various examples described herein are not mutually exclusive and may exist in various combinations and permutations.

### BRIEF DESCRIPTION OF DRAWINGS

These and other features, aspects, and advantages of the disclosure will become better understood with regard to the following descriptions, claims, and accompanying drawings. It is to be noted, however, that the drawings illustrate only several examples of the disclosure and, therefore, are not to be considered limiting of the scope of the disclosure.

FIG. 1 is a schematic diagram of a refining system for producing aviation fuel according to embodiments of the disclosure;

FIG. 2 is an illustration of a method for producing aviation fuel, such as with the refining system of FIG. 1, according to embodiments of the disclosure;

FIG. 3 is a schematic diagram of another refining system for producing aviation fuel according to embodiments of the disclosure;

FIG. 4 is an illustration of a method for producing aviation fuel, such as with the refining system of FIG. 3, according to embodiments of the disclosure;

FIG. 5 is a schematic diagram of a controller of a refining system according to embodiments of the disclosure; and

FIG. 6 is an illustration of a method for producing aviation fuel as performed by a controller according to embodiments of the disclosure.

### DETAILED DESCRIPTION

So that the manner in which the features and advantages of the examples of the systems and methods disclosed herein, as well as others, which will become apparent, may be understood in more detail, a more particular description of examples of systems and methods briefly summarized above may be had by reference to the following detailed description of examples thereof, in which one or more are further illustrated in the appended drawings, which form a part of this specification. It is to be noted, however, that the drawings illustrate only various examples of the examples of the systems and methods disclosed herein and are therefore not to be considered limiting of the scope of the systems and methods disclosed herein as it may include other effective examples as well.

As used herein, the term “C_{x-y} compounds,” in which x and y are positive integer values, refers to hydrocarbon-based compounds, each compound containing between x and y carbon atoms, x and y inclusive. For example, a C₃₋₅ fraction or stream refers to a mixture that substantially contains or entirely contains hydrocarbon-based compounds, each compound containing 3, 4, or 5 carbon atoms. Additionally, it may be noted that, in certain cases, a C_{x-y} fraction may not include a respective compound having each of the referenced integer values. As one example, a C₄₋₈ fraction can be a stream that contains compounds of 4, 5, and 7 carbon atoms, without any compounds of 6 or 8 carbon atoms. As used herein, the term “Cₓ₊ compounds,” in which x is a positive integer value, refers to hydrocarbon-based compounds, each compound containing at least x carbon atoms. For example, a C₃₊ fraction refers to a mixture that substantially contains or entirely contains hydrocarbon-based compounds, each compound containing 3 or more (e.g., 3, 4, 5, 6, and so forth) carbon atoms.

As used herein, the term “Cₓ₋ compounds,” in which x is a positive integer value, refers to hydrocarbon-based compounds, each compound containing no more than x carbon atoms. For example, a C₄₋ fraction refers to a mixture that substantially contains or entirely contains hydrocarbon-based compounds, each compound containing 4, 3, 2, or 1 carbon atoms. It may be noted that, in certain cases, a “Cₓ₋ fraction” may also include hydrogen (H₂), in addition to hydrocarbons having x or fewer carbon atoms. The term “substantially contains” means that the mixture includes more than 50%, or at least 51%, or at least 60%, or at least 70%, or at least 80% by weight of the relevant hydrocarbon-based compounds.

As used herein, the terms “hydrocracking reactor” and “isomerization reactor” can each refer to an area including one or more units, zones, or sub-zones, which can each perform a respective unit operation and collectively operate as a reactor. The reactors can include one or more reactors or reactor vessels, separators, strippers, flash drums, extraction columns, fractionation columns, heaters, coolers, exchangers, pipes, pumps, compressors, and controllers. As an example, a hydrocracking reactor or an isomerization reactor can include one or more heaters, one or more coolers, one or more separators, and/or a stripper. Additionally, a unit, such as a reactor, dryer, or vessel, can further include one or more zones or sub-zones that contain various equipment. In examples, a flash drum or flash includes relatively simple equipment to facilitate efficient separations between hydrocarbon-based compounds supplied thereto. In examples, a stripper includes more complex equipment than a flash drum and receives a stripping gas that facilitates more precise separations between hydrocarbon-based compounds supplied thereto. As used herein, the term “aviation fuel” refers to any suitable synthetic paraffinic kerosene (SPK), sustainable aviation fuel (SAF), or renewable jet fuel.

As transportation industries move to reduce their carbon footprints, sustainable transportation fuels are becoming even more significant. To this end, certain facilities may implement renewable feedstocks as a replacement for all or a portion of petroleum products that are included in transportation fuels. For example, SAF or an SPK constituent thereof may be produced from a growing list of renewable or sustainable resources, such as fats, oils, greases, grains, seeds, waste streams, and so forth. However, in the emerging sustainability-focused environment, a low or insufficient yield of useable fuels may be produced from current refining practices of sustainable resources, thus increasing the amount of the resources that are utilized. As such, Applicant has recognized a need for systems and methods to provide aviation fuel at enhanced yields and efficiency, such as by improving or optimizing a configuration of unit operations for sustainable refining systems.

In some embodiments, renewable diesel for aviation fuel production may be produced by hydrotreating renewable feedstocks containing triglycerides such as fats, oils, or greases, and free fatty acids derived from those triglycerides. Certain hydrodeoxygenation (HDO) reactions produce renewable diesel that may primarily contain C₁₆ and C₁₈ normal alkanes. Competing reactions may also produce byproducts including C₁₅ and C₁₇ normal alkanes. Minor byproducts of C₁₄₋ and C₁₉₊ normal alkanes may also be formed during HDO reactions, depending upon the fatty acid distributions of the renewable feedstocks used. The resulting HDO renewable diesel feedstock or mixture may be processed into aviation fuel by (1) fractionating compounds having a proper boiling point for aviation fuel use (nominally C₈₋₁₈ compounds) from smaller C₈₋ compounds and larger C₁₈₊ compounds in the mixture, and (2) isomerizing aviation fuel-range compounds to lower a freeze point of the mixture to suitable levels within existing and/or renewable aviation fuel specifications.

Embodiments of refining systems disclosed here position a fractionator as a front unit in the system, rather than at the end, for better flow management and efficient separation of the desired aviation fuel product from compounds that are too small or too large to be used as aviation fuel. Material that includes a higher boiling point than aviation fuel, such as a C₁₈₊ fraction, is obtained as the bottom product from the fractionator. This configuration of the refining system thus directs only the C₁₈₊ fraction to the hydrocracking reactor. As presently recognized, the yield of aviation fuel can be maximized by hydrocracking those C₁₈₊ compounds into a plurality of aviation fuel range compounds and smaller compounds corresponding to a naphtha, liquefied petroleum gas (LPG), and/or fuel gas size range, also denoted as light ends. In other words, the C₁₈₊ fraction may be fed or supplied to a hydrocracking reactor to crack it into a C₈₋₁₈ product in the aviation fuel range and a lighter C₈₋ compound in the light end range.

In some embodiments, the hydrocracked products from the hydrocracking step are recycled to the fractionator as feed. Thus, the C₁₈₊ compounds that are too large for use as aviation fuel can be recycled to extinction, thereby converting substantially all feedstock into an aviation fuel or lighter products that may have higher value. Additionally, the normal alkanes of the C₁₈₊ fraction, having not been processed within the isomerization reactor, may diffuse into and out of the pores of a zeolite hydrocracking catalyst easier than the corresponding branched compounds. This efficiency enables lower cracking temperatures to perform compound size reduction, compared to prior art systems without the present unit configuration. In other words, the refining system may increase or maximize aviation fuel production by converting substantially all of the C₁₈₊ fraction material into lower boiling point compounds that are suitable for use in aviation fuel. The compound size adjustment may therefore include clear benefits over other systems that may not fully utilize the heavier compounds of the feedstock for aviation fuel production.

The C₈₋₁₈ fraction from the fractionator may be sent to an isomerization reactor to lower its freeze point to meet aviation fuel specifications by converting the normal alkanes into branched or iso-alkanes of the same molecular weight. Additionally, any light ends produced by cracking in the isomerization reactor may be separated from the aviation fuel product and returned to the fractionator. As such, light ends from the fractionator are not processed in the isomerization reactor. Therefore, the isomerization reactor only receives the C₈₋₁₈ fraction for isomerization. This allows for lower severity operation of the isomerization reactor and implementation of a reduced catalyst volume, compared to systems without the present unit configuration. Lower temperatures for both hydrocracking and isomerization steps limit or reduce production of light end byproducts, thus maximizing the yield of the most desirable aviation fuel product. As such, the present disclosure may separate normal alkanes into fractions suitable for their respective upgrading processes, thus efficiently modifying their molecular sizes and qualities, including boiling points, for maximized production of aviation fuel.

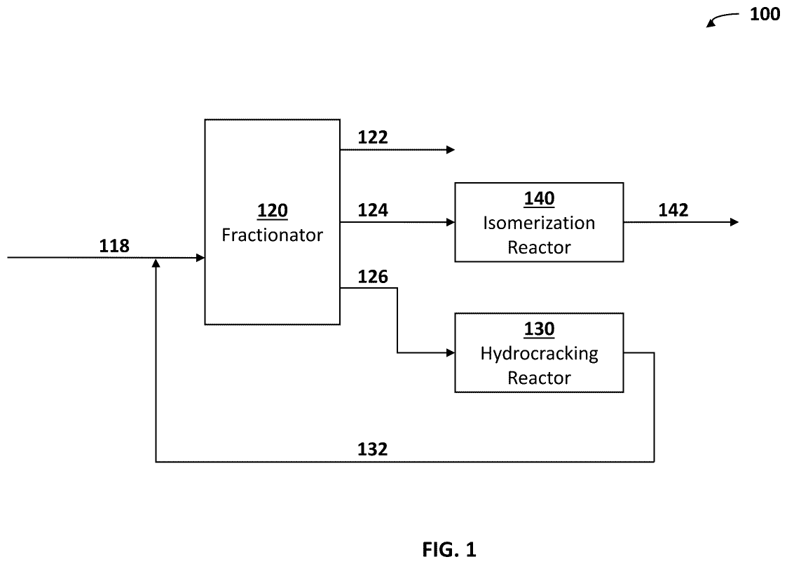

FIG. 1 is a schematic diagram of a refining system 100 for producing aviation fuel, according to some embodiments disclosed herein. The refining system 100, for example, may include multiple components or units that are optimally arranged to facilitate production of aviation fuel at higher efficiencies and yields than previously available systems. For example, the illustrated example of the refining system 100 includes a fractionator 120, a hydrocracking reactor 130, and an isomerization reactor 140. As will be understood, the present configuration of and interconnections in the refining system 100 provide improved management of compounds in which compounds over a threshold size are converted to sizes suitable for aviation fuel use and only compounds sized for aviation fuel are supplied to the isomerization reactor 140. As one example, positioning the fractionator 120 upstream of the hydrocracking reactor 130 and the isomerization reactor 140 facilitates these and other benefits disclosed herein.

The refining system 100 utilizes a renewable diesel feedstock 118 as a feedstock for producing aviation fuel. The renewable diesel feedstock 118 may be a hydrodeoxygenated (HDO) renewable diesel feedstock, including normal alkanes produced by hydrodeoxygenation of glycerides, such as diglycerides, triglycerides, and/or their derivatives. For example, the renewable diesel feedstock 118 is produced by hydrotreating triglycerides and/or triglyceride derivatives, such as fats, oils, greases, and/or free fatty acids. This oxygen removal mechanism generally removes undesired oxygen from feed materials as H₂O, thus conserving the carbon content of the renewable diesel feedstock 118. In certain examples, the production of the renewable diesel feedstock 118 includes additional oxygen removal mechanisms, such as decarboxylation that removes CO₂ and/or decarbonylation that removes CO. In some examples, the hydrodeoxygenation of triglycerides also causes decarboxylation and/or decarbonylation to occur. As such, references herein to hydrodeoxygenation also include any suitable decarboxylation and/or decarbonylation that occurs along with the hydrodeoxygenation. The renewable diesel feedstock 118 of certain examples is hydrotreated by hydrodeoxygenation in a respective, hydrogen-rich atmosphere to produce the renewable diesel feedstock.

The examples of hydrodeoxygenation of triglycerides implemented herein generate alkanes that, unlike free fatty acids, do not include a carboxyl functional group that entail further processing. As such, the renewable diesel feedstock 118 contains normal alkanes or straight-chain hydrocarbons ranging from C₁ to C₁₈₊, In certain examples, a majority of the renewable diesel feedstock contains C₁₆ and C₁₈ normal alkanes. Use of alkanes in the fractionator 120 also provides further versatility to processing steps, such as by enabling later discussed recycle loops to seamlessly integrate with the feed to the fractionator. Additionally, the lower boiling point temperatures of alkanes compared to fatty free acids enables fractionation to proceed at lower temperatures, such that the fractionator 120 operates with lower temperatures and reduced energy usage, as compared to a comparable fractionator operating with free fatty acids.

The renewable diesel feedstock 118 is supplied to the fractionator 120, which separates the renewable diesel feedstock 118 into fractions or streams of alkanes having specific properties, such as a range of distillation temperatures or boiling points. The fractionator 120 includes a first vessel that has a first inlet, a first outlet, a second outlet, and a third outlet. In certain examples, the fractionator 120 operates in a continuous process that separates or divides the hydrocarbons therein based on pre-determined cut points established based on physical properties, such as boiling points or sizes. In particular, the fractionator 120 and/or renewable diesel feedstock 118 receive thermal energy from a heat source to generate a thermal gradient within the first vessel, which ranges from hottest temperatures near the bottom to coldest near the top of the first vessel. In some examples, the heat source includes a preheater, a heater, a fired heater, a furnace, and/or a reboiler. The hydrocarbons within the first vessel therefore vaporize at respective boiling points and rise until met with a region having a respective condensation temperature, at which a fraction having a desired composition can be removed.

In the illustrated embodiment, the fractionator 120 separates the renewable diesel feedstock 118 into three fractions: a light fraction 122 having substantially C₁₋₈ or C₈₋ compounds, a middle fraction or aviation fuel-range fraction 124 having substantially C₈₋₁₈ compounds, and a heavy fraction 126 having substantially C₁₈₊ compounds. These components are also referred to as a C₈₋ fraction, a C₈₋₁₈ fraction, and a C₁₈₊ fraction, in examples. The aviation fuel-range fraction 124 contains compounds with a suitable boiling point temperature for use as aviation fuel, such as sustainable aviation fuel and/or renewable jet fuel. In examples, the fractionator 120 separates the compounds within a threshold range of boiling point temperatures, associated with certain C₈₋₁₈ compounds, and outputs them through the second outlet for further processing into aviation fuel. The light fraction 122 contains compounds with boiling point temperatures that are below the threshold range and thus can be provided as naphtha, LPG, and/or fuel gas by the refining system 100. The light fraction 122 is continuously removed or sent through the first outlet of the fractionator 120, in certain examples. The heavy fraction 126, containing compounds with boiling point temperatures that are above the threshold range suitable for use as aviation fuel, can be continuously removed through the third outlet of the fractionator 120.

As recognized herein, the present refining system 100 upgrades, or adds value to, compounds of the heavy fraction 126 within the hydrocracking reactor 130 to increase a yield of aviation fuel. The hydrocracking reactor 130 includes a second vessel that has a second inlet and a fourth outlet. In examples, the second inlet of the hydrocracking reactor 130 is connected to and in fluid communication with the third outlet of the fractionator 120 to receive at least a portion of the heavy fraction 126 therefrom. In some examples, the hydrocracking reactor 130 receives an entirety of the heavy fraction 126. In certain examples, a drag stream is removed from the heavy fraction 126 upstream of the hydrocracking reactor 130, which receives a remaining portion of the heavy fraction 126. Certain drag streams removed from the heavy fraction 160 are sold or utilized as a diesel product, in some examples. Within the hydrocracking reactor 130, the heavy fraction 126 containing C₁₈₊ compounds are subject to hydrocracking to produce a hydrocracked product 132 that contains any suitable alkanes, such as C₁₋₁₈₊ compounds. Certain C₁₈₊ compounds of the heavy fraction 126 are cracked within the hydrocracking reactor 130 into a first portion of compounds in the C₈₋₁₈ range and a second portion of compounds in the C₈₋ range.

In more detail, compounds of the heavy fraction 126 are converted into two or more respective, smaller compounds when exposed to operating conditions in the hydrocracking reactor 130. The operating conditions of the hydrocracking reactor 130 may include a high temperature and a high hydrogen pressure, provided with a zeolite hydrocracking catalyst. The hydrocracking catalyst of some examples includes a precious metal on a zeolite catalyst. In some examples, the hydrocracking catalyst is not sulfided, thus facilitating direct supply of the hydrocracked product 132 to the fractionator 120 (after any cooling and/or separations from recycle gas), without requiring use of hydrogen sulfide gas. In some examples, avoiding the use of hydrogen sulfide gas is desirable for systems including an isomerization catalyst containing precious metal because the sulfur would otherwise poison or negatively affect the precious metal of the isomerization catalyst. In some examples, the isomerization catalyst can include a base metal instead of a precious metal and thus be unaffected by hydrogen sulfide gas, such that the hydrocracking catalyst can be sulfided without negative effects.

Additionally, to facilitate the hydrocracking reactions, the hydrocracking reactor 130 can have an operating temperature in a range between about 400 and about 800° F. (between about 204.4 and about 426.7° C.). In some examples, the operating temperature is in a range between about 300 and about 700° F. (between about 148.9 and about 371.1° C.). In some examples, the operating temperature is in a range between about 500 and about 900° F. (between about 260.0 and about 482.2° C.). The partial pressure of hydrogen in the hydrocracking reactor 130 is at least 200 psi, in some examples. In some examples, the partial pressure of hydrogen is at least 300, 400, 500, 600, 700, 800, 900, 1,000, 1,200, 1,500, 2,000, 2,500, or more psi. The hydrogen supplied to the hydrocracking reactor 130 may be provided by any suitable hydrogen source. It should be understood that, in some examples, one or more C₁₈₊ compounds may remain in the hydrocracked product 132. For example, certain compounds produced from cracking large C₁₉₊ compounds include C₁₈₊ compounds and/or not all C₁₈₊ compounds of the heavy fraction 126 may be cracked in a first pass through the hydrocracking reactor 130. As such, the hydrocracked product 132 of certain examples includes a wide variety of alkanes (e.g., C₁₋₁₈₊ compounds), while the heavy fraction 126 contains substantially C₁₈₊ compounds and excludes substantially C₁₋₁₇ compounds.

Compared to certain traditional operations, the disclosed refining system 100 having the fractionator 120 upstream of both the hydrocracking reactor 130 and the isomerization reactor 140 enables operating conditions of the hydrocracking reactor 130 to be customized and/or optimized for cracking the heavy fraction 126. For example, the heavy fraction 126 supplied to the hydrocracking reactor 130 may include only C₁₈₊ normal alkanes. The normal alkanes diffuse into and out of pores of the zeolite hydrocracking catalyst more easily or efficiently than branched compounds, enabling lower cracking temperatures to be used for compound size reduction in the hydrocracking reactor 130. In examples, the lower temperature limits or reduces production of light end byproducts, thus increasing or maximizing the yield of the more desirable aviation fuel product. The aviation fuel yield is further improved because the refining system 100 does not direct compounds already within the desired C₈₋₁₈ range to hydrocracking. In other words, over-cracking that otherwise produces undesired light ends is reduced or avoided. The refining system 100 also reduces or minimizes a reactor size and corresponding capital expenses implemented for hydrocracking, because only the specific C₁₈₊ compounds to be reduced are supplied to the hydrocracking reactor 130. Compared to higher temperature reactions, the lower temperatures utilized by the refining system 100 decrease the rate of undesired thermal cracking reactions that would otherwise lower yield of desired products and increase the rate of coke formation on the catalyst. Reduced coke formation is desired based on coke production reducing desired product yield via use of carbon content for forming coke, not aviation fuel, and deactivating the catalyst more rapidly, thus requiring more frequent catalyst changes and consequently more process down time.

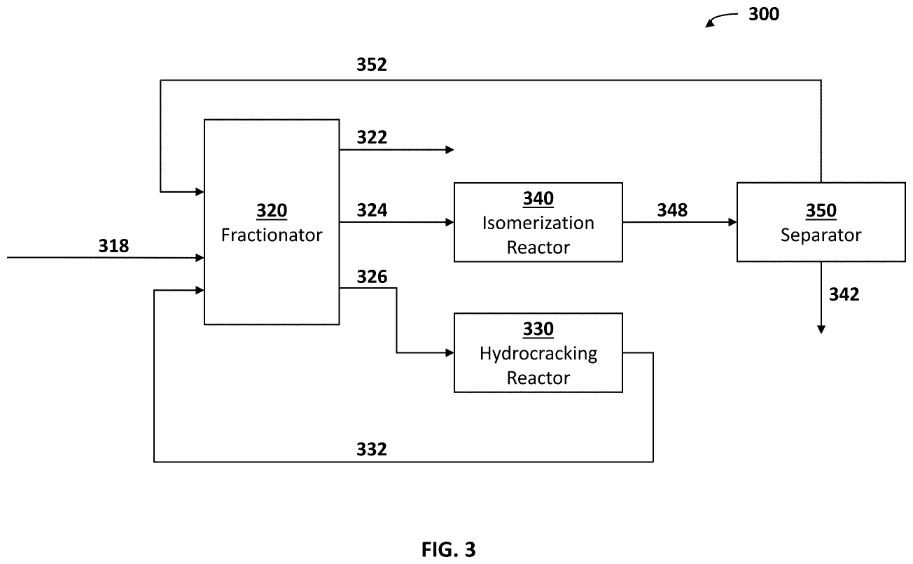

The fourth outlet of the hydrocracking reactor 130 is connected to recycle at least a portion of the hydrocracked product 132 to the fractionator 120 or its feed. For example, the fourth outlet is connected to and in fluid communication with the first inlet of the fractionator 120. The hydrocracked product 132 is therefore mixed with the renewable diesel feedstock 118 that is fed to the fractionator 120. In other examples, the fourth outlet may be connected to another inlet of the fractionator 120, as discussed with reference to FIG. 3 below. The fractionator 120 receives an entirety of the hydrocracked product 132 or a portion thereof, in certain examples. The hydrocracked product 132 of some examples is cooled and separated from recycle gas of the hydrocracking reactor 130 before entering the fractionator 120. In any case, the refining system 100 includes recycling the hydrocracked product 132 to the fractionator 120. As such, all compounds that have boiling points that are above boiling points for aviation fuel are recycled to extinction, thereby converting all input material of the refining system 100 into aviation fuel or lighter products. Additionally, the fractionator 120 includes dual functions of separating the initial renewable diesel feedstock 118 into fractions, as well as separating the hydrocracked product 132 into the fractions.

From the fractionator 120, the aviation fuel-range fraction 124 of C₈₋₁₈ compounds is supplied to the isomerization reactor 140 to be further processed or refined into an aviation fuel product 142. In some examples, the aviation fuel product 142 is an SPK product that is blended with an aromatic-containing fuel, such as an aromatic sustainable fuel and/or a petroleum fuel, to form an SAF having various standardized properties. The aromatic sustainable fuel of certain examples is obtained from processing of a sustainable source (e.g., sugars) and/or from an aromatic chemical production facility. As an example, a predominantly paraffinic SPK product may be blended with the aromatic-containing fuel to produce SAF containing a minimum content of aromatic compounds, as specified by one or more ASTM standards. As another example, to meet certain ASTM standards for aviation turbine fuel (D1655 and D7566), an aviation fuel may constitute up to 50% of the SPK product that is blended with a petroleum-derived jet fuel to produce the aviation fuel with final physical and chemical properties that correspond to standardized aviation use. In certain examples, the aviation fuel product 142 is used directly as an SAF without blending with an aromatic-containing fuel. The isomerization reactor 140 includes a third vessel that has a third inlet and a fifth outlet. In examples, the third inlet of the isomerization reactor 140 is connected to and in fluid communication with the second outlet of the fractionator 120 to receive at least a portion of the aviation fuel-range fraction 124. The isomerization reactor 140 receives an entirety of the aviation fuel-range fraction 124 or a portion thereof, in certain examples. The aviation fuel-range fraction 124 of certain examples also includes C₈₋₁₈ compounds of the hydrocracked product 132 provided to the fractionator 120 from the hydrocracking reactor 130, which enhances product yield.

The isomerization reactor 140 isomerizes the C₈₋₁₈ compounds of the aviation fuel-range fraction 124 into the aviation fuel product 142, which is output to the fifth outlet of the isomerization reactor 140. For example, operating conditions in the isomerization reactor 140 are selected to lower a freeze point of the aviation fuel-range fraction 124 to meet aviation fuel specifications by converting normal alkanes into branched or iso-alkanes of the same molecular weight. The isomerization reactor 140 isomerizes compounds with an isomerization catalyst in the presence of hydrogen, which is provided by any suitable hydrogen source. For example, the partial pressure of hydrogen in the isomerization reactor 140 is at least 200 psi, in some examples. In some examples, the partial pressure of hydrogen is at least 300, 400, 500, or more psi. The isomerization reactor 140 and the hydrocracking reactor 130 may receive hydrogen from separate hydrogen sources or from a shared hydrogen source, in examples. In some examples, the isomerization reactor 140 includes an operating temperature in a range between about 400 and about 800° F. (between about 204.4 and about 426.7° C.). In some examples, the operating temperature is in a range between about 300 and about 700° F. (between about 148.9 and about 371.1° C.). In some examples, the operating temperature is in a range between about 500 and about 900° F. (between about 260.0 and about 482.2° C.).

The particular configuration of the refining system 100 further enhances the operation of the isomerization reactor 140. For example, because only C₈₋₁₈ compounds are isomerized, lower severity operation and a smaller catalyst volume are be used in the isomerization reactor 140, compared to systems that may also isomerize light ends or C₈₋ compounds. The refining system 100 may also exclude or avoid a stabilizer for adjusting an initial boiling point of the aviation fuel product 142, based on the specific separation of the aviation fuel-range fraction 124 from other components in the fractionator 120. The reduced demand for a stabilizer further enables the isomerization reactor 140 to be constructed with a smaller size and corresponding reduced capital cost. Removal of the C₈₋ compounds prior to processing also facilitates maintenance of a higher hydrogen partial pressure within the isomerization, thus providing both reduced deactivation of an isomerization catalyst and improved isomerization selectivity for the aviation fuel product 142.

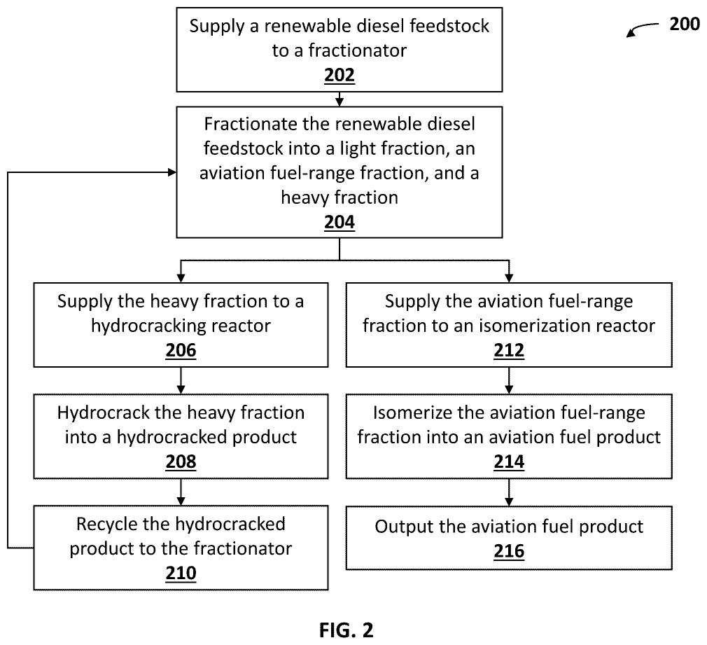

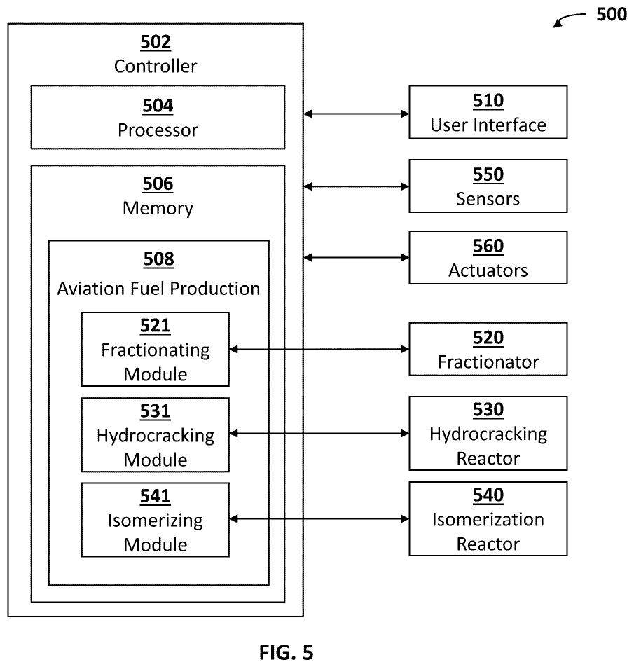

FIG. 2 is an illustration of a method 200 for producing aviation fuel, according to some embodiments disclosed herein. The method 200 is described with reference to the refining system 100 of FIG. 1. Additionally, the steps or actions of the method 200 may be completed, implemented, or controlled by a suitable control component, such as a controller 502 discussed with reference to FIG. 5. For example, the method 200 may be included in one or more programs, protocols, or instructions loaded into a memory 506 of the controller 502 and executed on one or more processors 504 of the controller 502.

At block 202 of the method 200, the refining system 100 (or a controller thereof) supplies a renewable diesel feedstock 118 to a fractionator 120. The renewable diesel feedstock 118 is a HDO or hydrodeoxygenated renewable diesel feedstock that contains normal alkanes produced from triglycerides, in certain examples. At block 204, the refining system 100 fractionates the renewable diesel feedstock into a light fraction 122, an aviation fuel-range fraction 124, and a heavy fraction 126. As noted above, the fractionator 120 may include a first inlet to receive the renewable diesel feedstock, a first outlet to output the light fraction 122, a second outlet to output the aviation fuel-range fraction 124, and a third outlet to output the heavy fraction 126.

At block 206, the refining system 100 supplies the heavy fraction 126 to a hydrocracking reactor 130. Thus, at block 208, the refining system 100 hydrocracks the heavy fraction 126 into a hydrocracked product 132. At block 210, the refining system 100 recycles the hydrocracked product 132 to the fractionator 120. The hydrocracking reactor 130 may include a second inlet to receive the heavy fraction 126 and a fourth outlet to supply the hydrocracked product 132 to the fractionator 120. As such, a recycle loop is provided to circulate the heavy fraction 126 through the hydrocracking reactor 130 and the fractionator 120 to produce smaller compounds that further increase the yield of aviation fuel.

Moreover, at block 212, the refining system 100 supplies the aviation fuel-range fraction 124 to an isomerization reactor 140. In certain examples, block 206 and block 212 are performed in parallel, such as during operations in which the refining system is operated in a continuous processing mode. At block 214, the refining system 100 isomerizes the aviation fuel-range fraction 124 into an aviation fuel product 142. For example, the isomerization reactor 140 may include a third inlet to receive the aviation fuel-range fraction 124 and a fifth outlet to output the aviation fuel product 142. As such, at block 216, the refining system 100 outputs the aviation fuel product 142 from the fifth outlet to be further utilized in or transported from the refining system 100.

FIG. 3 is a schematic diagram of another refining system 300 for producing aviation fuel, according to some embodiments disclosed herein. As illustrated, the refining system 300, for example, includes two recycle loops that cooperate to improve the yield, efficiency, and/or properties of aviation fuel produced by the refining system 300. The refining system 300 of FIG. 3 includes certain components or units that are similar to those discussed above with reference to FIG. 1. These components or units are similarly labeled, and their descriptions are not repeated in detail for improved clarity. For example, the refining system 300 includes a fractionator 320, a hydrocracking reactor 330, and an isomerization reactor 340.

As discussed above, the fractionator 320 may include a first vessel that has a first inlet, a first outlet, a second outlet, and a third outlet. The fractionator 320 separates the renewable diesel feedstock 318 into three fractions: a light fraction 322 having substantially C₁₋₈ or C₈₋ compounds, an aviation fuel-range fraction 324 having substantially C₈₋₁₈ compounds, and a heavy fraction 326 having substantially C₁₈₊ compounds. The hydrocracking reactor 330 may include a second vessel that has a second inlet to receive at least a portion of the heavy fraction 326 and a fourth outlet. Additionally, the isomerization reactor 340 may include a third vessel that has a third inlet to receive at least a portion of the aviation fuel-range fraction 324 and a fifth outlet. To illustrate another non-limiting example, the refining system 300 of FIG. 3 includes a fourth inlet into the fractionator 320 connected to and in fluid communication with the fourth outlet of the hydrocracking reactor 330 to receive at least a portion of a hydrocracked product 332 therefrom. The fourth inlet may be independent of the first inlet associated with the renewable diesel feedstock 318, thus providing an additional control variable for managing operation of the fractionator 320. In some examples, the fourth inlet is provided at a different tray or height of the fractionator 320, compared to the first inlet.

As an additional feature, the refining system 300 includes a separator 350 positioned downstream of the isomerization reactor 340 to further refine the aviation fuel produced by the refining system 300. For example, certain operations or examples of the isomerization reactor 340 generate additional C₈₋ light ends or compounds via cracking during isomerization of the aviation fuel-range fraction 324 having C₈₋₁₈ compounds. The fifth outlet of the isomerization reactor 340 therefore outputs a mixed product 348 having C₁₇₋ compounds. The separator 350 includes a fourth vessel having a fifth inlet, a sixth outlet, and a seventh outlet. The fifth inlet is connected to and in fluid communication with the fifth outlet of the isomerization reactor 340 to supply at least a portion of the mixed product 348 to the fourth vessel. In certain examples, the separator 350 is a flash drum or flash that performs separations based on flash evaporation of the mixed product 348. In some examples, the separator 350 includes a stripper, as well as an additional inlet that receives a suitable stripping gas for facilitating the desired separation therein.

Embodiments of the separator 350 include suitable operating conditions to separate or strip a produced light fraction 352 of C₈₋ compounds, or additional C₈₋ fraction, from the aviation fuel product of C₈₋₁₈ compounds. Accordingly, the sixth outlet at a top of the separator 350 is connected to recycle at least a portion of the produced light fraction 352 back to the fractionator 320, from which the produced light fraction 352 are directed through the first outlet of the fractionator 320 as the light fraction 322. Certain examples of the fractionator 320 include a sixth inlet that is connected to and in fluid communication with the sixth outlet of the separator 350. In other examples, the produced light fraction 352 may be mixed with the renewable diesel feedstock 318. Additionally, the seventh outlet at a bottom of the separator 350 outputs the relatively heavier aviation fuel product 342, which includes C₈₋₁₈ compounds within targeted aviation fuel specifications.

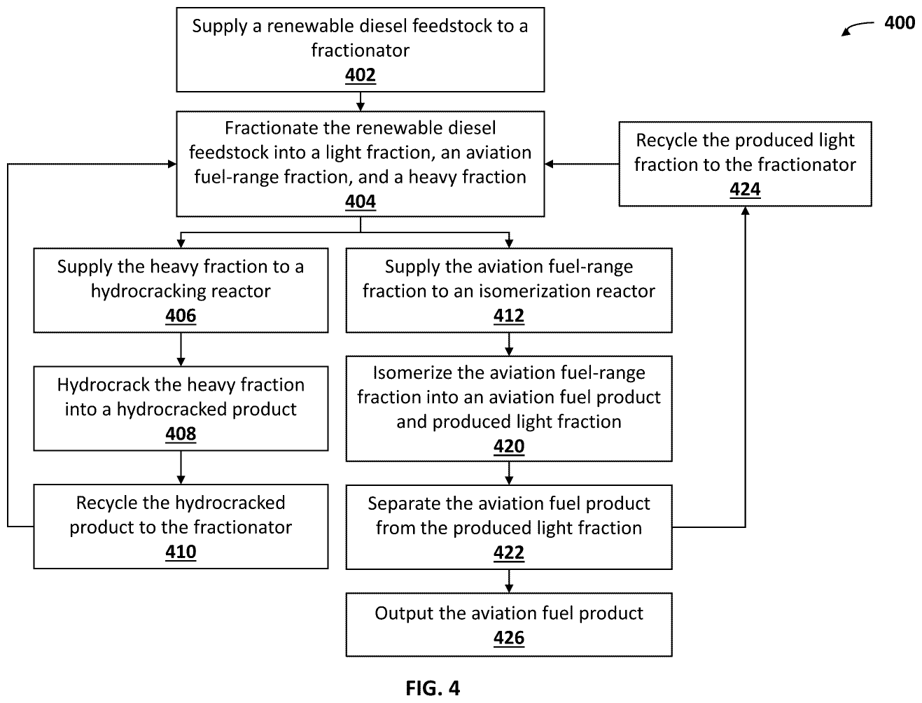

FIG. 4 is an illustration of a method 400 for producing aviation fuel, according to some embodiments disclosed herein. The method 400, for example, is described with reference to the refining system 300 of FIG. 3. Additionally, the steps or actions of the method 400 may be completed, implemented, or controlled by a suitable control component, such as a controller 502 discussed with reference to FIG. 5. For example, the method 400 may be included in one or more programs, protocols, or instructions loaded into a memory 506 of the controller 502 and executed on one or more processors 504 of the controller 502.

The method 400 includes certain blocks or actions that are similar to those of method 200 discussed above with reference to FIG. 2. These blocks, including blocks 402, 404, 406, 408, 410, and 412, and their descriptions are not repeated here for improved clarity. Looking to block 420, the refining system 300 isomerizes the aviation fuel-range fraction 324 into an aviation fuel product 342 and a produced light fraction 352. For example, as discussed above, certain operations of the isomerization reactor 340 cause production of additional C₈₋ compounds. At block 422, the refining system 300 separates the aviation fuel product 342 from the produced light fraction 352. Certain examples include performing the separation by stripping the produced light fraction 352 from the aviation fuel product 342 within a separator 350.

At block 424, the refining system 300 recycles the produced light fraction 352 to the fractionator 320. As such, a second recycle loop is provided within the refining system to enable further refinement of the aviation fuel product 342 at desirably increased yields. At block 426, the refining system 300 outputs the aviation fuel product 342 to be used in and/or transported from the refining system 300.

FIG. 5 is a simplified diagram illustrating a control system 500 for managing the producing of aviation fuel according to some embodiments disclosed herein. In some examples, the control system 500 includes a controller 502 or one or more controllers. Certain examples include the controller 502 being in signal communication with various other controllers throughout or external to a refining system, such as one of the refining systems 100, 300 discussed above. Additionally, the controller 502 may be considered a supervisory controller or other suitable control component for managing the refining system, as discussed herein.

The controller 502 of various examples disclosed herein include one or more processors, such as processor 504, as well as a memory or machine-readable storage medium, such as memory 506. As used herein, a “machine-readable storage medium” may be any electronic, magnetic, optical, or other physical storage apparatus to contain or store information such as executable instructions, data, and the like. For example, any machine-readable storage medium described herein may be any of random access memory (RAM), volatile memory, non-volatile memory, flash memory, a storage drive, a hard drive, a solid state drive, any type of storage disc, and the like, or a combination thereof. The memory 506 stores or includes instructions executable by the processor 504. As used herein, a “processor” includes, for example, one processor or multiple processors included in a single device or distributed across multiple computing devices. The processor 304 may be at least one of a central processing unit (CPU), a semiconductor-based microprocessor, a graphics processing unit (GPU), a field-programmable gate array (FPGA) to retrieve and execute instructions, a real time processor (RTP), other electronic circuitry suitable for the retrieval and execution instructions stored on a machine-readable storage medium, or a combination thereof.

As used herein, “signal communication” refers to electric communication such as hard wiring two components together or wireless communication, as understood by those skilled in the art. For example, wireless communication may be Wi-Fi®, Bluetooth®, ZigBee, or forms of near field communications. In addition, signal communication may include one or more intermediate controllers or relays disposed between elements that are in signal communication with one another. In the drawings and specification, several examples of systems and methods of producing aviation fuel are disclosed. The controller 502 includes instructions 508 to produce the aviation fuel according to the examples disclosed herein.

In some examples, the instructions 508 cause the refining system to produce the aviation fuel product. For example, the controller 502 may receive any suitable product specifications and/or operating conditions from a user interface 510 and/or from data pre-loaded into the memory 506. To produce the aviation fuel product to the desired or target specifications, the controller 502 sends signals to and/or receives signals from a fractionator 520, a hydrocracking reactor 530, an isomerization reactor 540, and/or any other units associated with the refining system. The signals transmitted by the controller 502 may include operating parameters for each unit, such as temperatures, length of operating time, amount of incoming feedstock, amount of product to be produced, as well as other parameters. As an example, the controller 502 selects an operating temperature for the hydrocracking reactor 530, which is lower than a reference operating temperature of a reference hydrocracking reactor that is downstream instead of upstream of an associated reference isomerization reactor. Additionally, the controller 502 selects an operating temperature for the isomerization reactor 540 that is lower than a reference operating temperature of a reference isomerization reactor that is upstream instead of downstream of an associated reference hydrocracking reactor. The instructions 508 and/or any other suitable portion of the controller 502 may include any suitable software applications, routines, or programming to produce the aviation fuel product. For examples, the instructions 508 can include a fractionating module 521 for controlling operation of the fractionator 520, a hydrocracking module 531 for controlling operation of the hydrocracking reactor 530, and an isomerizing module 541 for controlling operation of the isomerization reactor 540.

The control system 500 of some examples may also include various sensors and meters disposed through the refining system, such as the illustrated sensors 550 communicatively coupled to the controller 502. The sensors and meters may be in signal communication with the controller 502 and may provide data or feedback to the controller 502 to determine various properties of each unit and/or product at various stages in the process. The sensors and meters may measure flow, density, chemical properties, temperature, pressure, and/or other properties, utilized for monitoring the production of the aviation fuel product. Based on data received from the sensors 550, the controller 502 can monitor the process from initiation through completion to produce the aviation fuel product. In some examples, the control system 500 also includes various actuators 560 in signal communication with the controller 502 to facilitate adjustment and/or control of the various operating parameters, properties, and so forth. The actuators 560 can include any suitable pneumatic, electric, mechanical, and/or hydraulic control components, including control valves, pumps, compressors, heating elements, electrical switches, and so forth. The controller 502 can instruct one or more actuators 560 on demand and/or at a predetermined or selected schedule to adjust flows, densities, chemical properties, temperatures, pressures, and/or other properties utilized during production of the aviation fuel product.

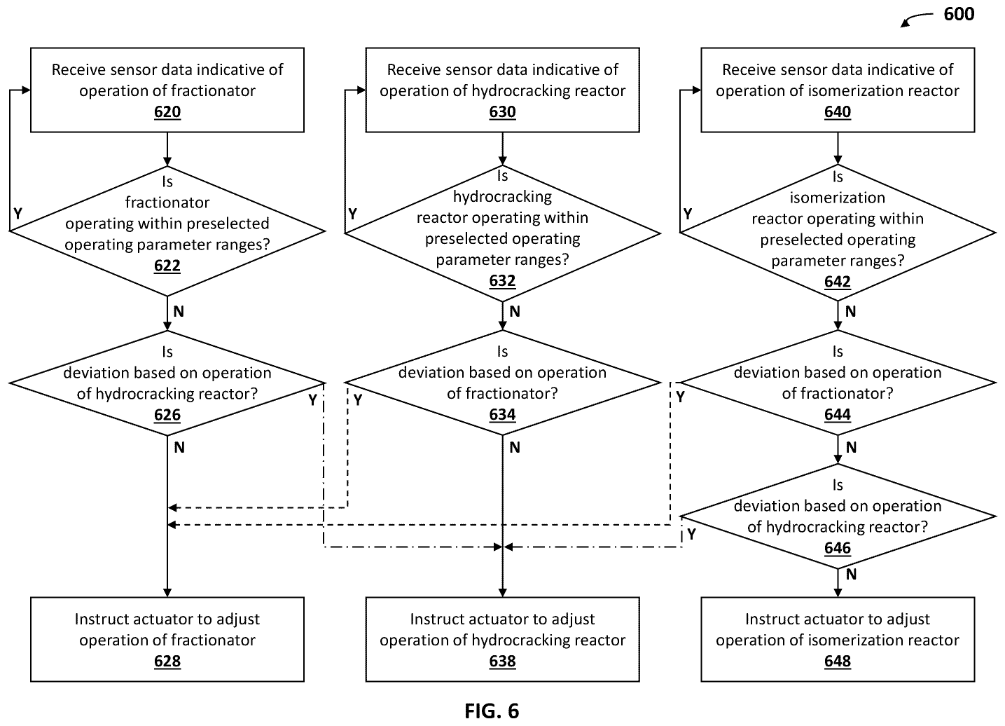

FIG. 6 is an illustration of a method 600 for controlling production of aviation fuel, according to some embodiments disclosed herein. The method 600, for example, is described with reference to the control system 500 of FIG. 5. The order in which the operations are described is not intended to be construed as a limitation, and any number of the described blocks may be combined in any order and/or in parallel to implement the method. Additionally, the steps or actions of the method 600 may be completed, implemented, or controlled by the controller 502 discussed above. The method 600 may be included in one or more modules, programs, protocols, or instructions of the controller 502. For example, certain steps can be performed by one or more of the fractionating modules 521, the hydrocracking module 531, and the isomerizing module 541, respectively. As a non-limiting example, the fractionating module 521 may perform the steps of the left-hand column of the method 600, the hydrocracking module 531 may perform the steps of the center column of the method 600, and the isomerizing module 541 may perform the steps of the right-hand column of the method 600. In certain examples, each column of the method 600 is performed in parallel, such as via the various modules of the controller 502, which can communicate with one another as described below.

As recognized herein, the fractionator 520, the hydrocracking reactor 530, and the isomerization reactor 540 work cooperatively to produce aviation fuel in a system arranged as discussed above, in which operation of an upstream component can influence operation of any downstream component. The present example of the method 600 illustrates certain control steps that can improve the interoperation of equipment arranged according to the present disclosure, such as by allowing specialization of control components and/or more rapid detection and/or prevention of any undesired operations or products by the fractionator 520, the hydrocracking reactor 530, and the isomerization reactor 540.

Looking first to the left-hand column, at block 620 of the method 600, the controller 502 receives sensor data indicative of operation of the fractionator 520. For example, the controller 502 may receive one or more signals indicative of flow, density, chemical properties, temperature, pressure, and/or other properties associated with operation of the fractionator 520. At block 622, the controller 502 determines whether the fractionator 520 is operating within one or more preselected operating parameter ranges. In some examples, the operating parameter ranges may be preselected and/or updated on demand in response to instructions received from a user interface or device, from another controller, and/or from another module of the control system. The controller 502 can evaluate each received operating parameter individually or collectively to identify any operating parameters that are currently deviating, or predicted to deviate in the near future, from their corresponding ranges. In response to determining that the fractionator 520 is operating within the preselected operating parameter ranges or that no deviations are present, the controller 502 returns to block 620 to continue monitoring the sensor data associated with the fractionator 520.

In response to determining that, at block 622, the fractionator 520 includes one or more operating parameters that are not within their associated preselected ranges, the controller 502 proceeds to block 626 to determine whether a deviation is based on operation of the hydrocracking reactor 530. That is, the fractionator 520 receives the renewable diesel feedstock and a recycle stream of hydrocracked product from the hydrocracking reactor 530. Based on the sensor data, the controller 502 can determine whether the deviation in the fractionator 520 originates with or is based at least in part on the hydrocracked product from the hydrocracking reactor 530. In response to determining that, at block 626, the deviation is not based on operation of the hydrocracking reactor 530, the controller 502 continues to block 628 to instruct one or more actuators to adjust operation of the fractionator 520. The controller 502 can thus correct the fractionator 520 to reduce or eliminate the deviation, before continued monitoring of the fractionator 520 at block 620.

In response to determining that, at block 626, the deviation is based on operation of the hydrocracking reactor 530, the controller 502 proceeds to block 638 to instruct one or more actuators to adjust operation of the hydrocracking reactor 530. In some examples in which the fractionating module 521 performs steps of the left-hand column of the method 600, the fractionating module 521 provides one or more signals to the hydrocracking module 531 (as illustrated by a dash-dotted line) to enable the hydrocracking module 531 to perform the adjustments to the hydrocracking reactor 530.

Turning to the center column of the method 600, at block 630, the controller 502 receives sensor data indicative of operation of the hydrocracking reactor 530. As discussed in detail above, the hydrocracking reactor 530 is in a recycle loop with the fractionator 520, which can each affect one another during operation. Additionally, the hydrocracking reactor 530 and the fractionator 520 are both upstream of the isomerization reactor 540, which does not affect operation of the hydrocracking reactor 530 and the fractionator 520. At block 632, the controller 502 determines whether the hydrocracking reactor 530 is operating within one or more preselected operating parameter ranges. As noted above, the controller 502 can monitor any suitable operating parameter associated with operation of the hydrocracking reactor 530, and the operating parameter ranges may be preselected and/or updated on demand in response to instructions received from any suitable device or module. In response to determining that the hydrocracking reactor 530 is operating within the preselected operating parameter ranges or that no deviations are present, the controller 502 returns to block 630 to continue monitoring the sensor data associated with the hydrocracking reactor 530.

In response to determining that the hydrocracking reactor 530 includes one or more operating parameters that are not within their associated preselected ranges, the controller 502 proceeds to block 634 to determine whether a deviation is based on operation of the fractionator 520. In response to determining that, at block 634, the deviation is based on operation of the fractionator 520, the controller 502 proceeds to block 628 to instruct one or more actuators to adjust operation of the fractionator 520. In some examples in which the hydrocracking module 531 performs steps of the center column of the method 600, the hydrocracking module 531 provides one or more signals to the fractionating module 521 (as illustrated by a dashed line) to enable the fractionating module 521 to perform the adjustments to the fractionator 520.

In response to determining that, at block 634, the deviation is not based on operation of the fractionator 520, the controller 502 continues to block 638 to instruct one or more actuators to adjust operation of the hydrocracking reactor 530. The controller 502 can thus correct the hydrocracking reactor 530 to reduce or eliminate the deviation, before continued monitoring of the hydrocracking reactor 530 at block 630.

With focus on the right-hand column of the method 600, at block 640, the controller 502 receives sensor data indicative of operation of the isomerization reactor 540. As discussed in detail above, the isomerization reactor 540 is downstream of both the fractionator 520 and the hydrocracking reactor 530, which each affect operation of the isomerization reactor 540. At block 642, the controller 502 determines whether the isomerization reactor 540 is operating within one or more preselected operating parameter ranges. As noted above, the controller 502 can monitor any suitable operating parameter associated with operation of the isomerization reactor 540, and the operating parameter ranges may be preselected and/or updated on demand in response to instructions received from any suitable device or module. In response to determining that the isomerization reactor 540 is operating within the preselected operating parameter ranges or that no deviations are present, the controller 502 returns to block 640 to continue monitoring the sensor data associated with the isomerization reactor 540.

In response to determining that the isomerization reactor 540 includes one or more operating parameters that are not within their associated preselected ranges, the controller 502 proceeds to block 644 to determine whether a deviation is based on operation of the fractionator 520. In response to determining that the deviation is based on operation of the fractionator 520, the controller 502 proceeds to block 628 to instruct one or more actuators to adjust operation of the fractionator 520. In some examples in which the isomerizing module 541 performs steps of the right-hand column of the method 600, the isomerizing module 541 provides one or more signals to the fractionating module 521 (as illustrated by a dashed line) to enable the fractionating module 521 to perform the adjustments to the fractionator 520.

In response to determining that, at block 644, the deviation is not based on operation of the fractionator 520, the controller 502 continues to block 646 to determine whether the deviation is based on operation of the hydrocracking reactor 530. In response to determining that the deviation is based on operation of the hydrocracking reactor 530, the controller 502 proceeds to block 638 to instruct one or more actuators to adjust operation of the hydrocracking reactor 530. For examples in which the isomerizing module 541 performs steps of the right-hand column of the method 600, the isomerizing module 541 provides one or more signals to the hydrocracking module 531 (as illustrated by a dash-dotted line) to enable the hydrocracking module 531 to perform the adjustments to the hydrocracking reactor 530.

In response to determining that, at block 646, the deviation is not based on operation of the fractionator 520 or the hydrocracking reactor 530, the controller 502 continues to block 648 to instruct one or more actuators to adjust operation of the isomerization reactor 540. The controller 502 can thus correct the isomerization reactor 540 to reduce or eliminate the deviation, before continued monitoring of the isomerization reactor 540 at block 640. Accordingly, the controller 502 performing the method 600 enables each of the fractionator 520, the hydrocracking reactor 530, and the isomerization reactor 540 to operate in an improved and cohesive manner, leveraging their arrangement to facilitate production of aviation fuel at higher efficiencies and yields than previously available systems.

This application claims priority to, and the benefit of U.S. Provisional Application No. 63/548,081, filed Nov. 10, 2023, titled “SYSTEMS AND METHODS FOR PRODUCING AVIATION FUEL,” the disclosure of which is incorporated herein by reference in its entirety.

Although specific terms are employed herein, the terms are used in a descriptive sense only and not for purposes of limitation. Embodiments of systems, methods, and controllers have been described in considerable detail with specific reference to the illustrated examples. However, it will be apparent that various modifications and changes can be made within the spirit and scope of the embodiments of systems, methods, and controllers as described in the foregoing specification, and such modifications and changes are to be considered equivalents and part of this disclosure.

What is claimed is:

1. A method to produce aviation fuel, the method comprising:
fractionating a renewable diesel feedstock in a fractionator to produce a C₈₋ fraction, a C₈₋₁₈ fraction, and a C₁₈₊ fraction;
providing the C₈₋₁₈ fraction to an isomerization reactor to produce an aviation fuel product;
supplying at least a portion of the C₁₈₊ fraction to a hydrocracking reactor to produce a hydrocracked product; and
recycling at least a portion of the hydrocracked product to the fractionator for fractionating along with the renewable diesel feedstock.

2. The method of claim 1, wherein the renewable diesel feedstock comprises a hydrodeoxygenated renewable diesel.

3. The method of claim 1, wherein the renewable diesel feedstock contains normal alkanes produced by hydrodeoxygenation of glycerides.

4. The method of claim 1, further comprising hydrotreating a renewable feedstock containing triglycerides, triglyceride derivatives, or a combination thereof in a hydrogen-rich atmosphere to produce the renewable diesel feedstock.

5. The method of claim 1, further comprising:
mixing the hydrocracked product with the renewable diesel feedstock directly upstream of the fractionator.

6. The method of claim 1, wherein the renewable diesel feedstock is supplied to a first inlet of the fractionator, and wherein the at least a portion of the hydrocracked product is supplied to a second inlet of the fractionator.

7. The method of claim 1, wherein the recycling at least a portion of the hydrocracked product to the fractionator further comprises recycling an entirety of the hydrocracked product.

8. The method of claim 1, further comprising:
producing an additional C₈₋ fraction in the isomerization reactor;
providing the aviation fuel product and the additional C₈₋ fraction to a separator to separate the aviation fuel product from the additional C₈₋ fraction; and
providing the additional C₈₋ fraction to the fractionator.

9. The method of claim 1, further comprising:
selecting an operating temperature of the hydrocracking reactor, the operating temperature being lower than a reference operating temperature of a reference hydrocracking reactor downstream of a reference isomerization reactor.

10. A method to produce aviation fuel, the method comprising:
supplying a hydrodeoxygenated renewable diesel feedstock to a fractionator;
fractionating the hydrodeoxygenated renewable diesel feedstock into a C₈₋ fraction, a C₈₋₁₈ fraction, and a C₁₈₊ fraction;
providing the C₈₋₁₈ fraction to an isomerization reactor to produce an aviation fuel product;
supplying at least a portion of the C₁₈₊ fraction to a hydrocracking reactor to produce a hydrocracked product, the hydrocracking reactor cracking one or more heavy compounds of the C₁₈₊ fraction into two or more lighter compounds; and
recycling at least a portion of the hydrocracked product to the fractionator for fractionating along with the hydrodeoxygenated renewable diesel feedstock.

11. The method of claim 10, further comprising:
hydrodeoxygenating a triglyceride feedstock to produce the hydrodeoxygenated renewable diesel feedstock.

12. The method of claim 10, further comprising:
producing an additional C₈₋ fraction in the isomerization reactor;
providing the aviation fuel product and the additional C₈₋ fraction to a separator to separate the aviation fuel product from the additional C₈₋ fraction; and
providing the additional C₈₋ fraction to the fractionator.

13. A system to produce aviation fuel, the system comprising:
a fractionator having a first inlet to receive a renewable diesel feedstock, a first outlet, a second outlet, and a third outlet, the fractionator operable to fractionate the renewable diesel feedstock into a C₈₋ fraction output through the first outlet, a C₈₋₁₈ fraction output to the second outlet, and a C₁₈₊ fraction output to the third outlet;
a hydrocracking reactor having a second inlet and a fourth outlet, the second inlet connected to and in fluid communication with the third outlet to receive the C₁₈₊ fraction, the hydrocracking reactor operable to hydrocrack the C₁₈₊ fraction into a hydrocracked product, and the fourth outlet connected to recycle the hydrocracked product to the fractionator; and
an isomerization reactor having a third inlet and a fifth outlet, the third inlet connected to and in fluid communication with the second outlet to receive the C₈₋₁₈ fraction, and the isomerization reactor operable to isomerize the C₈₋₁₈ fraction into an aviation fuel product output to the fifth outlet.

14. The system of claim 13, wherein the renewable diesel feedstock contains normal alkanes produced by hydrodeoxygenation of glycerides, free fatty acids, or combinations thereof.

15. The system of claim 13, wherein a majority of the hydrodeoxygenated renewable diesel contains C₁₆ and C₁₈ normal alkanes.

16. The system of claim 13, further comprising a separator having a fifth inlet connected to and in fluid communication with the fifth outlet, a sixth outlet to supply an additional C₈₋ fraction to the fractionator, and a seventh outlet to output the aviation fuel product.

17. The system of claim 13, wherein the fourth outlet is connected to and in fluid communication with the first inlet or an additional inlet of the fractionator.

18. The system of claim 13, further comprising a hydrogen source connected to and in fluid communication with the hydrocracking reactor, the isomerization reactor, or both.

19. The system of claim 13, further comprising a controller in signal communication with the fractionator, the hydrocracking reactor, and the isomerization reactor, and wherein the controller is configured to transmit signals to one or more of the fractionator, the hydrocracking reactor, or the isomerization reactor to adjust production of the aviation fuel product.

20. The system of claim 19, wherein the controller is configured to adjust operation of the fractionator, the hydrocracking reactor, or both in response to detecting that the isomerization reactor is deviating from one or more preselected operating parameter ranges.
